(19) United States
(12) Patent Application Publication
(10) Pub. No.: US 2013/0135532 A1
(43) Pub. Date: May 30, 2013

(54) APPARATUS AND METHOD FOR COMMUNICATING WIRELESS VIDEO BASED ON ZIGBEE NETWORK PROTOCOL

(71) Applicants: Byung Gil HAN, Daegu-si (KR); Eun Chang CHOI, Daejeon-si (KR)

(72) Inventors: Byung Gil HAN, Daegu-si (KR); Eun Chang CHOI, Daejeon-si (KR)

(73) Assignee: Electronics and Telecommunications Research Institute, Daejeon (KR)

(21) Appl. No.: 13/563,144

(22) Filed: Jul. 31, 2012

(30) Foreign Application Priority Data
Nov. 28, 2011 (KR) 10-2011-0125000

(51) Int. Cl. H04N 5/38

(52) U.S. Cl. 348/723; 348/E05.093

(57) ABSTRACT

A method and an apparatus for communicating wireless videos based on ZigBee network are provided. The method includes: receiving, a video transmitting apparatus, a video transmitting request from a user through a button input apparatus; receiving videos from a video input apparatus when an interrupt is generated and storing the received videos in a transmitting buffer, by setting a timer; and when data exceeding a predetermined capacity of the transmitting buffer are stored in the transmitting buffer, splitting the videos stored in the transmitting buffer into ZigBee packets and transmitting the split videos to a video receiving apparatus. According to the present invention, the video transmitting apparatus and the video receiving apparatus can control a power supply for peripheral apparatuses such as a video input apparatus, a video output apparatus, by a message, if necessary, and can minimize power consumed by the peripheral apparatuses.

### CROSS-REFERENCE TO RELATED APPLICATIONS

This application claims the benefit of priority Korean Patent Application No. 10-2011-0125000 filed on Nov. 28, 2011, all of which are incorporated by reference in their entirety herein.

### BACKGROUND OF THE INVENTION

1. Field of the Invention

The present invention relates to wireless communication, and more particularly, to an apparatus and a method for communicating wireless videos based on ZigBee network standard protocols.

2. Related Art

ZigBee network communications, which are one of the representative technologies of a short range wireless sensor network for providing low-power and low-cost bidirectional wireless communications, are standardized by upper software standard protocols such as networking, applications, security, and the like, in ZigBee alliance that is International Industry Meeting, based on hardware protocols standardized in Institute of Electrical and Electronics Engineers (IEEE) 802.15.4 workshop subcommittee in 2003. The ZigBee communication technology using an Industrial, Scientific and Medical (ISM) frequency band and having a physical transmission rate of a maximum of 250 Kbps has been mainly used for center data transmission, such as home automation, smart energy, and the like. Further, as a demand for telecom applications in the ZigBee network increases, a standardization work has been progressed. Recently, a ZigBee telecom application profile including standards for voice communications in the ZigBee network has been announced. However, the ZigBee telecom application profile does not include standards for communication videos and as a result, related application technologies using video communications in the ZigBee network are insufficient.

In order to solve the above problems, a separate codec for compressing videos in the ZigBee network may be used or a high-speed non-standard ZigBee chip exceeding a standard rate of 250 Kbps may be used. In this case, a high-performance central processing unit consuming a considerable amount of power is required.

Therefore, a need exists for low-power and low-cost wireless communication apparatus and method capable of maintaining compatibility with products while observing the ZigBee standard protocols.

### SUMMARY OF THE INVENTION

The present invention provides a method for supporting video communications in a ZigBee network using low-power and low-cost apparatuses that can be driven even by power from a battery.

In an aspect, there is provided a method for communicating wireless videos based on ZigBee network standard protocols by a video transmitting apparatus, including: receiving a video transmitting request from a user through a button input apparatus; receiving videos from a video input apparatus when an interrupt is generated and storing the received videos in a transmitting buffer, by setting a timer; and when data exceeding a predetermined capacity of the transmitting buffer are stored in the transmitting buffer, splitting the videos stored in the transmitting buffer into ZigBee packets and transmitting the split videos to a video receiving apparatus.

The method for communicating wireless videos may further include: when transmission for a single frame of the videos completes, transmitting a command message informing that the transmission of the single frame ends to the video receiving apparatus.

The method for communicating wireless videos may further include: prior to the receiving of the videos from the video input apparatus, transmitting an establishing request message including information of a size or a format of the videos to be transmitted to the video receiving apparatus, wherein when an establishing response message including information on whether the videos to be transmitted are output is received from the video receiving apparatus, the videos are received from the video input apparatus.

The method for communicating wireless videos may further include: when a transmission ending request is received from the user, transmitting an ending message to the video receiving apparatus; and when an ending response message that is a response to the ending message is received from the video receiving apparatus, ending a video input and inactivating the video input apparatus.

The method for communicating wireless videos may further include: prior to the receiving of the video transmitting request, configuring a ZigBee network with the video receiving apparatus.

In another aspect, there is provided a method for communicating wireless videos based on ZigBee network standard protocols by a video receiving apparatus, including: receiving an establishing request message including information of a size and a format of videos to be received from a video transmitting apparatus; determining whether a size or a format of the videos to be received is output; when the videos to be received are output, generating the establishing response message, transmitting the generated establishing response message to the video transmitting apparatus, and preparing for outputting the videos; and receiving video packets in which videos to be received are split into ZigBee packets from the video transmitting apparatus and storing the video packets in a receiving buffer; and when data exceeding a predetermined capacity of the receiving buffer are stored in the receiving buffer, integrating the video packets stored in the receiving buffer as video data and sequentially outputting the integrated video data to a video output apparatus.

The method for communicating wireless videos may further include: when a size or a format of the videos to be received is not output, generating an establishing response message so as not to be transmitted to the video transmitting apparatus and re-receiving the establishing request message.

The method for communicating wireless videos may further include: receiving a command message informing that transmission of the video packets corresponding to a single frame of the videos to be received ends from the video transmitting apparatus; and initializing an output position of the video data.

The method for communicating wireless videos may further include: receiving an ending message indicating that a transmission ending request is received from a user from the video transmitting apparatus; transmitting an ending response message that is a response to the ending message to the video transmitting apparatus; and stopping reception of the video packets and inactivating the video output apparatus.

The method for communicating wireless videos may further include: prior to the receiving of the establishing request message from the video transmitting apparatus, configuring a ZigBee network with the video transmitting apparatus.

In another aspect, there is provided a video transmitting apparatus for communicating wireless videos based on ZigBee network standard protocols, wherein the video transmitting apparatus: receives a video transmitting request from a user through a button input apparatus; receives videos from a video input apparatus when an interrupt is generated and stores the received videos in a transmitting buffer, by setting a timer; and when data exceeding a predetermined capacity of the transmitting buffer in the transmitting buffer are stored in the transmitting buffer, splits the videos stored in the transmitting buffer into ZigBee packets and transmits the split videos to a video receiving apparatus.

In another aspect, there is provided a video receiving apparatus for communicating wireless videos based on ZigBee network standard protocols, wherein the video receiving apparatus: receives an establishing request message including information of a size and a format of videos to be received from a video transmitting apparatus; determines whether a size or a format of the videos to be received is output; when the videos to be received are output, generates the establishing response message, transmits the generated establishing response message to the video transmitting apparatus, and prepares for outputting the videos; and receives video packets in which videos to be received are split into ZigBee packets from the video transmitting apparatus and stores the video packets in a receiving buffer; and when data exceeding a predetermined capacity of the receiving buffer are stored in the receiving buffer, integrates the video packets stored in the receiving buffer as video data and sequentially outputs the integrated video data to a video output apparatus.

### BRIEF DESCRIPTION OF THE DRAWINGS

FIG. 1 is a diagram showing an example of a flow chart of a video transmitting apparatus and a video receiving apparatus performing wireless video communications based on ZigBee network standard protocols according to an exemplary embodiment of the present invention.

FIGS. 2A and 2B are diagrams showing an example of a flow chart of an operation of the video transmitting apparatus performing wireless video communications based on the ZigBee network standard protocols according to the exemplary embodiment of the present invention.

FIGS. 3A and 3B are diagrams showing an example of a flow chart of an operation of the video receiving apparatus performing the wireless video communications based on the ZigBee network standard protocols according to the exemplary embodiment of the present invention.

FIG. 4 is a block diagram showing a configuration of an apparatus for communicating wireless videos based on the ZigBee network standard protocols according to the exemplary embodiment of the present invention.

### DESCRIPTION OF EXEMPLARY EMBODIMENTS

Hereinafter, exemplary embodiments of the present invention will be described in detail with reference to the accompanying drawings. It is to be noted that in giving reference numerals to components of each of the accompanying drawing, like reference numerals refer to like elements even though the like components are shown in different drawings. Further, in describing exemplary embodiments of the present invention, well-known functions or constructions will not be described in detail since they may unnecessarily obscure the understanding of the present invention.

In addition, in describing components of the present specification, terms such as first, second, A, B, (a), (b), etc. may be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

Further, in the present specification, a wireless communication network is mainly described. An operation performed in the wireless communication network may control a network in a system (for example, a base station) supervising corresponding wireless communication networks and may be performed during a process of transmitting data or performed in user equipments coupled with the corresponding wireless networks.

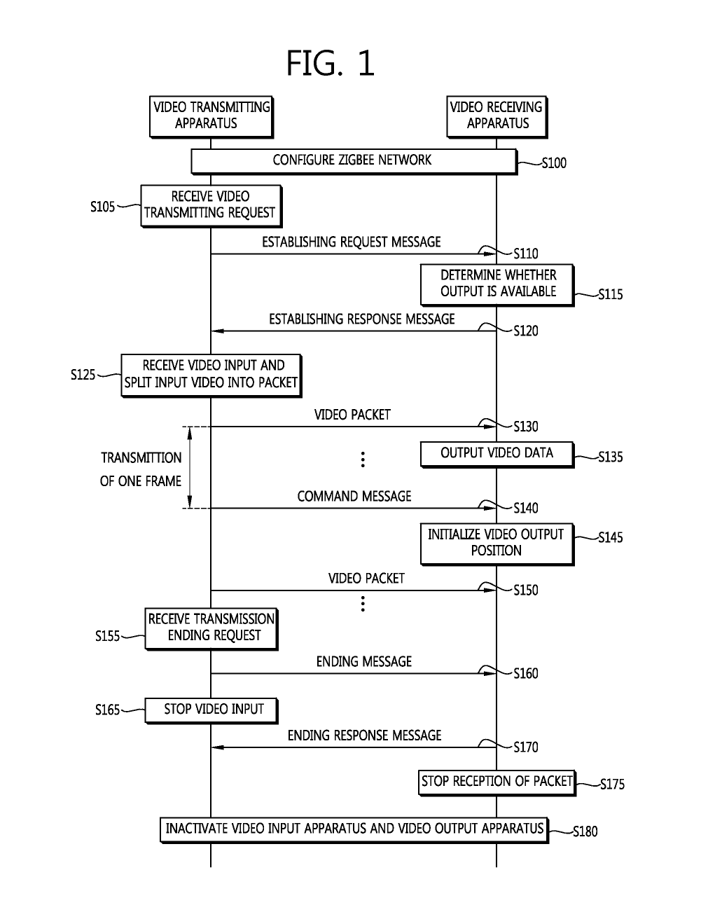

FIG. 1 is a diagram showing an example of a flow chart of a video transmitting apparatus and a video receiving apparatus performing wireless video communications based on ZigBee network standard protocols according to an exemplary embodiment of the present invention.

Referring to FIG. 1, a ZigBee network is configured between a video transmitting apparatus and a video receiving apparatus (S100). In order to provide a video communication function based on a ZigBee network standard, the ZigBee network is configured. Each apparatus is set as one of a coordinator, a router, and an end device according to the ZigBee network standard, wherein a network is configured between respective apparatuses. In this case, addresses differentiating each apparatus may follow an address representation scheme based on the ZigBee.

The video transmitting apparatus receives a video transmitting request from a user through separate button input apparatuses (or, a button input apparatus in the video transmitting apparatus) (S105).

The video transmitting apparatus receiving the video transmitting request transmits an establishing request message for communicating videos to the video receiving apparatus (S110). The establishing request message for communicating videos includes information such as a size, a format, and the like, of videos to be transmitted.

The video receiving apparatus receiving the establishing request message determines whether the size, the format, and the like, of videos to be transmitted can be output (S115), generates an establishing response message, and transmits the generated establishing response message to the video transmitting apparatus (S120). Next, the video receiving apparatus prepares for outputting videos and waits for receiving videos.

The video transmitting apparatus receiving the establishing response message receives the videos to be transmitted from the separate video input apparatus (or the video input apparatus included in the video transmitting apparatus) and splits the received videos into several ZigBee packets (S125). The transmittable size is limited in the single ZigBee packet and therefore, the video transmitting apparatus splits the videos of the single frame into packets and transmits the split packets.

For example, by using a timer, the video transmitting apparatus may receive a predetermined amount of video data when an interrupt is generated, store the received video data in a transmitting buffer therein, and store the video data in the transmitting buffer until the ZigBee packets are a transmittable maximum size. Next, the packets stored in the transmitting buffer may be transmitted at a time. Alternatively, the data stored in the transmitting buffer may be transmitted in a single packet.

The video transmitting apparatus transmits the input video data (hereinafter, video packets) split into the ZigBee packets to the video receiving apparatus (S130). When the transmission of all of the video packets of the video data completes, a process of receiving the subsequent video data from the video input apparatus and transmitting the video packets is repeated.

The video receiving apparatus receiving the video packets stores the video packets in the receiving buffer and integrates video data and sequentially outputs the video data to the video output apparatus (S135).

When the transmission of the video packets for the single frame completes, the video transmitting apparatus transmits a command message to the video receiving apparatus informing that the transmission of the single frame ends (S140). The video receiving apparatus receiving the command message initializes the output position of the videos (S145). From the subsequent video packet, this is to start an output from a start portion of a screen.

The video transmitting apparatus again performs a process of splitting the video data for the subsequent frame into the ZigBee packets and then, transmitting the video packets to the video receiving apparatus (S150). Even in this case, by setting the timer, the video transmitting apparatus may receive a predetermined amount of video data when the interrupt is generated, store the received video data therein, and store the video data stored in the transmitting buffer until the ZigBee packets are a transmittable maximum size. The data packets for the subsequent frame are again output from the start portion of the screen.

When the transmission ending request is received from the external input apparatuses while the video transmitting apparatus performs the transmission of the video data (S155), the video transmitting apparatus transmits the ending message to the video receiving apparatus (S160) and stops the video input from the video input apparatus (S165).

The video receiving apparatus transmits an ending response message that is a response to the ending message to the video transmitting apparatus (S170) and stops the reception of the video data packets (S175).

The video transmitting apparatus inactivates the video input apparatus and the video receiving apparatus inactivates the video output apparatus (S180). This is to reduce power consumption.

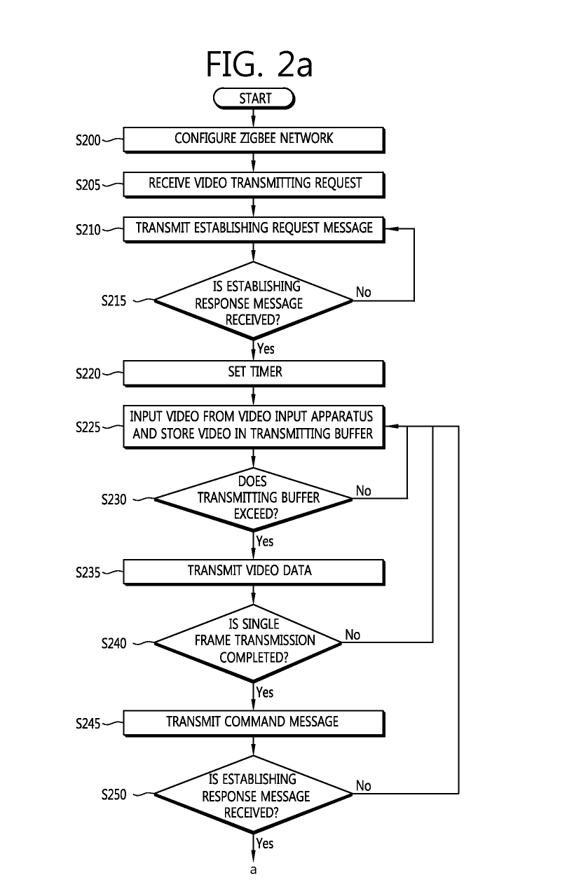

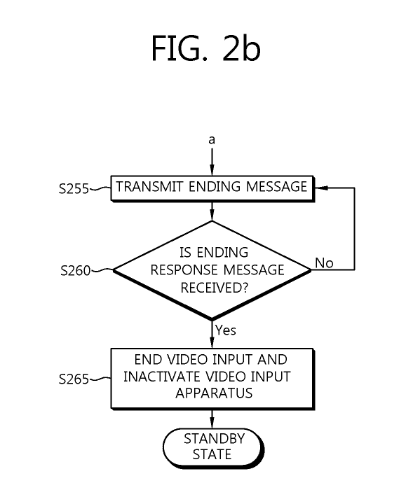

FIGS. 2A and 2B are diagrams showing an example of a flow chart of an operation of the video transmitting apparatus performing wireless video communications based on the ZigBee network standard protocols according to the exemplary embodiment of the present invention.

Referring to FIG. 2, the ZigBee network is configured between the video transmitting apparatus and the video receiving apparatus (S200). In order to provide a video communication function based on a ZigBee network standard, the ZigBee network is configured.

The video transmitting apparatus receives a video transmitting request from a user through separate button input apparatuses (or, a button input apparatus in the video transmitting apparatus) (S205).

The video transmitting apparatus receiving the video transmitting request transmits an establishing request message for communicating videos to the video receiving apparatus (S210). The establishing request message for communicating videos includes information such as a size, a format, and the like, of videos to be transmitted.

The video transmitting apparatus receives the establishing response message including information on whether the videos to be transmitted may be output from the video receiving apparatus (S215). When the establishing response message is not received, the establishing request message is retransmitted (S210).

The video transmitting apparatus receiving the establishing response message sets the timer (S220) to receive the videos to be transmitted from the separate video input apparatus (or the video input apparatus included in the video transmitting apparatus) when the interrupt is generated and store the received videos in the transmitting buffer (S225).

The video transmitting apparatus determines whether the data exceed the transmitting buffer (S230) and if it is determined that the data exceeding the transmitting buffer are stored, transmits the input video data (hereinafter, referred to as video packets) split into the ZigBee packets to the video receiving apparatus (S235). Since the transmittable size is limited in the single ZigBee packets, the video data of the single frame are stored in the transmitting buffer until the video data are the transmittable maximum size of the ZigBee packets and then, the video packets are transmitted.

When the transmission of the video packets for the single frame completes, the video transmitting apparatus repeats a process of completing the transmission of all of the video packets of the video data, receiving the subsequent video data from the video input apparatus, and transmitting the video packets.

When the transmission of the video packets for the single frame completes (S240), the video transmitting apparatus transmits a command message to the video receiving apparatus informing that the transmission of the single frame ends (S245). The video receiving apparatus receiving the command message is to initialize the output position of the videos and start the output from the start portion of the screen from the subsequent data packet.

The video transmitting apparatus again performs a process of splitting the video data for the subsequent frame into the ZigBee packets when receiving the transmission ending request and then, transmitting the video packets to the video receiving apparatus.

When the video transmitting apparatus receives the transmission ending request from the external input apparatus, and the like (S250), the video transmitting apparatus transmits the ending message to the video receiving apparatus (S255).

When the video transmitting apparatus receives the ending response message that is the response to the ending message from the video receiving apparatus (S260), the video transmitting apparatus ends the video input so as to stop the reception of the video data packets and inactivates the video input apparatus (S265). This is to reduce power consumption.

Thereafter, the video transmitting apparatus is in a standby state.

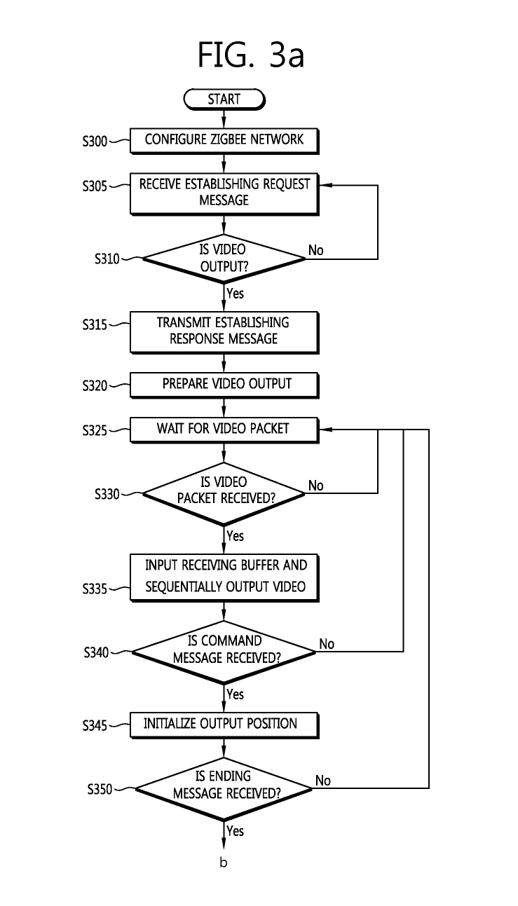

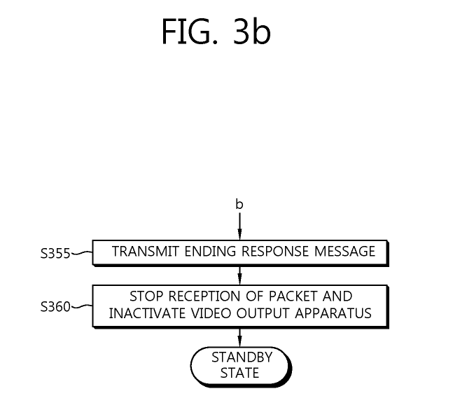

FIGS. 3A and 3B are diagrams showing an example of a flow chart of an operation of the video receiving apparatus performing the wireless video communications based on the ZigBee network standard protocols according to the exemplary embodiment of the present invention.

Referring to FIG. 3, the video receiving apparatus configures the ZigBee network with the video transmitting apparatus. In order to provide the video communication function based on a ZigBee network standard, the ZigBee network is configured.

The video receiving apparatus receives the establishing request message for communication videos from the video transmitting apparatus receiving the video transmitting request (S305). The establishing request message for communicating videos includes information such as a size, a format, and the like, of videos to be transmitted.

When the size, the format, and the like, of videos to be transmitted can be output (S310), the video receiving apparatus receiving the establishing request message generates the establishing response message and transmits the generated establishing response message to the video transmitting apparatus (S315). However, when the size, the format, and the like, of the received videos cannot be output, the video receiving apparatus re-receives the establishing request message (S305).

The video receiving apparatus prepares for outputting videos (S320) and waits for receiving the video packets (S325).

When the video receiving apparatus receives the video packets that are the input video data split into the ZigBee packets from the video transmitting apparatus (S330), the video receiving apparatus stores the video packets in a receiving buffer, are integrated as the video data, and sequentially outputs the integrated video data to the video output apparatus (S335).

When the video receiving apparatus receives the command message informing that the transmission of the video packets for the single frame completes and thus, the transmission of the single frame ends from the video transmitting apparatus (S340), the video receiving apparatus initializes the output position of the videos (S345). From the subsequent video packet, this is to start an output from a start portion of a screen.

The video receiving apparatus repeatedly performs the reception of the video packets until the video receiving apparatus receives the command message, inputs the received video packets to the receiving buffer, and then, sequentially outputs the videos. In addition, the process is repeated until the video receiving apparatus receives the ending message from the video transmitting apparatus.

When the video receiving apparatus receives the ending message from the video transmitting apparatus (S350), the video receiving apparatus transmits the ending response message that is the response to the ending message to the video transmitting apparatus (S355), stops the reception of the video data packets, and inactivates the video output apparatus (S360).

Thereafter, the video receiving apparatus is in a standby state.

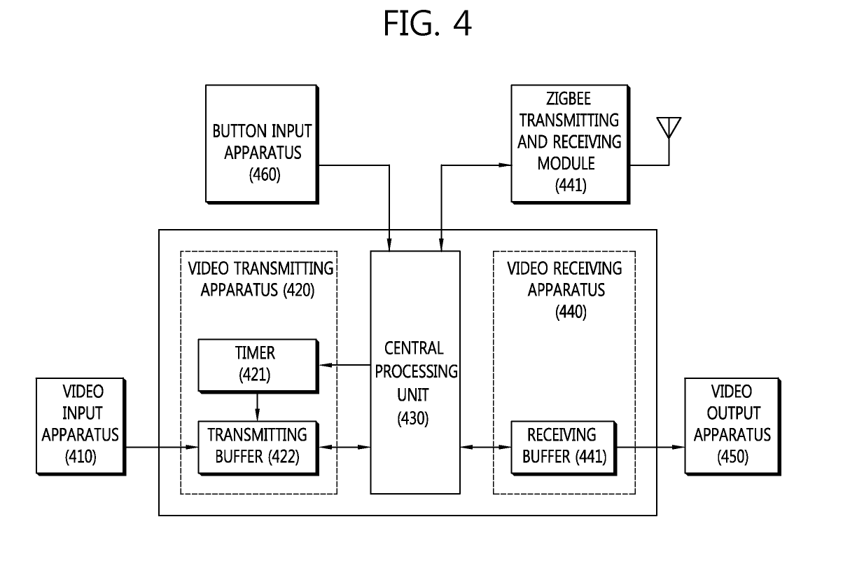

FIG. 4 is a block diagram showing a configuration of an apparatus for communicating wireless videos based on the ZigBee network standard protocols according to the exemplary embodiment of the present invention.

Referring to FIG. 4, an apparatus for communicating wireless videos includes a video input apparatus 410, a video transmitting apparatus 420, a central processing unit 430, a video receiving apparatus 440, a video output apparatus 450, a button input apparatus 460, and a ZigBee transmitting and receiving module 470.

The central processing unit 430 serves to transmit and receive signals among the video transmitting apparatus 420, the video receiving apparatus 440, the button input apparatus 460, and the ZigBee transmitting and receiving module 470. The signal processing passes through the central processing unit.

The ZigBee transmitting and receiving module 470 serves to transmit and receiving the signals from and to another apparatus for communicating wireless videos.

The video transmitting apparatus 430 further includes a timer and a transmitting buffer 422.

The video transmitting apparatus 420 receives the video transmitting request from the button input apparatus 460.

The video transmitting apparatus 420 transmits the establishing request message for communicating videos. The establishing request message for communicating videos includes information such as a size, a format, and the like, of videos to be transmitted.

The video transmitting apparatus 420 receives the establishing response message including the information on whether the videos to be transmitted can be output from the video receiving apparatus and if it is determined that the video transmitting apparatus 420 does not receive the establishing response message, retransmits the establishing request message.

The video transmitting apparatus 420 receives the videos to be transmitted from the separate video input apparatus 410 when the interrupt is generated, by setting the timer 421 and stores the received videos in the transmitting buffer 422.

The video transmitting apparatus 420 determines whether the data exceed the transmitting buffer 422 and if it is determined that the data exceeding the transmitting buffer 422 is stored, transmits the input video data split into the ZigBee packets. Since the transmittable size is limited in the single ZigBee packets, the video data of the single frame are stored in the transmitting buffer 422 until the video data are the transmittable maximum size of the ZigBee packets and then, the video packets are transmitted. When the transmission of all of the video packets of the video data completes, the process of receiving the subsequent video data from the video input apparatus 410 and transmitting the video packets is repeated.

The video transmitting apparatus 420 transmits the command message informing that the transmission of the single frame ends to the video receiving apparatus.

The video transmitting apparatus 420 again performs a process of splitting the video data for the subsequent frame into the ZigBee packets when receiving the transmission ending request and then, transmitting the video packets to the video receiving apparatus.

The video transmitting apparatus 420 receives the transmission ending request from the external input apparatuses, and the like, such as the button input apparatus 460 and transmits the ending message to the video receiving apparatus.

When the video transmitting apparatus 420 receives the ending response message that is the response to the ending message from the video receiving apparatus, the video transmitting apparatus ends the video input so as to stop the reception of the video data packets and inactivates the video input apparatus 410.

The video receiving apparatus 440 further includes a receiving buffer 441.

The video receiving apparatus 440 receives the establishing request message for communicating videos.

The video receiving apparatus 440 generates and transmits the establishing response message when the size, the format, and the like, of videos to be transmitted can be output. When the size, the format, and the like, of the received videos cannot be output, the video receiving apparatus 440 re-receives the establishing request message.

The video receiving apparatus 440 prepares for outputting videos and waits for receiving the video packets.

When the video receiving apparatus 440 receives the video packets that are the input video data split into the ZigBee packets, the video receiving apparatus 440 stores the video packets in the receiving buffer 441, integrates the stored video packets as the video data, and sequentially outputs the integrated video data to the video output apparatus 450.

When the video receiving apparatus 440 receives the command message informing that the transmission of the video packets for the single frame completes and thus, the transmission of the single frame ends, the video receiving apparatus initializes the output position of the videos. From the subsequent data packets, this is to start an output from a start portion of a screen.

The video receiving apparatus 440 repeatedly performs the reception of the video packets until the video receiving apparatus receives the command message, inputs the received video packets to the receiving buffer 441, and then, sequentially outputs the videos.

When the video receiving apparatus 440 receives the ending message, the video receiving apparatus 400 transmits the ending response message that is a response to the ending message, stops the reception of the video data packets, and inactivates the video output apparatus 450.

According to the exemplary embodiments of the present invention, the video transmitting apparatus and the video receiving apparatus can control a power supply for peripheral apparatuses such as a video input apparatus, a video output apparatus, and the like, by a message, if necessary, and can minimize power consumed by the peripheral apparatuses.

In addition, according to the exemplary embodiments of the present invention, the video communications are performed based on the ZigBee network standard protocols and therefore, the technologies, such as the network configuration, the network security, and the like, that are provided by the ZigBee network standard protocols can be easily used.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A method for communicating wireless videos based on ZigBee network standard protocols by a video transmitting apparatus, the method comprising:
receiving a video transmitting request from a user through a button input apparatus;
receiving videos from a video input apparatus when an interrupt is generated and storing the received videos in a transmitting buffer, by setting a timer; and
when data exceeding a predetermined capacity of the transmitting buffer are stored in the transmitting buffer, splitting the videos stored in the transmitting buffer into ZigBee packets and transmitting the split videos to a video receiving apparatus.

2. The method of claim 1, further comprising: when transmission for a single frame of the videos completes, transmitting a command message informing that the transmission of the single frame ends to the video receiving apparatus.

3. The method of claim 1, further comprising: prior to the receiving of the videos from the video input apparatus,
transmitting an establishing request message including information of a size or a format of the videos to be transmitted to the video receiving apparatus,
wherein when an establishing response message including information on whether the videos to be transmitted are output is received from the video receiving apparatus, the videos are received from the video input apparatus.

4. The method of claim 1, further comprising:
when a transmission ending request is received from the user, transmitting an ending message to the video receiving apparatus; and
when an ending response message that is a response to the ending message is received from the video receiving apparatus, ending a video input and inactivating the video input apparatus.

5. The method of claim 1, further comprising: prior to the receiving of the video transmitting request, configuring a ZigBee network with the video receiving apparatus.

6. A method for communicating wireless videos based on ZigBee network standard protocols by a video receiving apparatus, the method comprising:
receiving an establishing request message including information of a size and a format of videos to be received from a video transmitting apparatus;
determining whether a size or a format of the videos to be received is output;
when the videos to be received are output, generating the establishing response message, transmitting the generated establishing response message to the video transmitting apparatus, and preparing for outputting the videos; and
receiving video packets in which videos to be received are split into ZigBee packets from the video transmitting apparatus and storing the video packets in a receiving buffer; and
when data exceeding a predetermined capacity of the receiving buffer are stored in the receiving buffer, integrating the video packets stored in the receiving buffer as video data and sequentially outputting the integrated video data to a video output apparatus.

7. The method of claim 6, further comprising: when a size or a format of the videos to be received is not output, generating an establishing response message so as not to be transmitted to the video transmitting apparatus and re-receiving the establishing request message.

8. The method of claim 6, further comprising:
receiving a command message informing that transmission of the video packets corresponding to a single frame of the videos to be received ends from the video transmitting apparatus; and
initializing an output position of the video data.

9. The method of claim 6, further comprising:
receiving an ending message indicating that a transmission ending request is received from a user from the video transmitting apparatus;
transmitting an ending response message that is a response to the ending message to the video transmitting apparatus; and
stopping reception of the video packets and inactivating the video output apparatus.

10. The method of claim 6, further comprising: prior to the receiving of the establishing request message from the video transmitting apparatus, configuring a ZigBee network with the video transmitting apparatus.

11. A video transmitting apparatus for communicating wireless videos based on ZigBee network standard protocols, wherein the video transmitting apparatus:
receives a video transmitting request from a user through a button input apparatus;
receives videos from a video input apparatus when an interrupt is generated and stores the received videos in a transmitting buffer, by setting a timer; and
when data exceeding a predetermined capacity of the transmitting buffer in the transmitting buffer are stored in the transmitting buffer, splits the videos stored in the transmitting buffer into ZigBee packets and transmits the split videos to a video receiving apparatus.

12. The video transmitting apparatus of claim 11, wherein when transmission for a single frame of the videos completes, a command message informing that the transmission of the single frame ends is transmitted to the video receiving apparatus.

13. The video transmitting apparatus of claim 11, wherein prior to receiving the videos from the video input apparatus,
an establishing request message including information a size or a format of the videos to be transmitted is transmitted to the video receiving apparatus,
when an establishing response message including information on whether the videos to be transmitted are output is received from the video receiving apparatus, the videos are received from the video input apparatus.

14. The video transmitting apparatus of claim 11, wherein when a transmission ending request is received from the user, an ending message is transmitted to the video receiving apparatus; and
when an ending response message that is a response to the ending message is received from the video receiving apparatus, a video input ends and the video input apparatus is inactivated.

15. The video transmitting apparatus of claim 11, wherein prior to receiving the video transmitting request, it configures a ZigBee network with the video receiving apparatus.

16. A video receiving apparatus for communicating wireless videos based on ZigBee network standard protocols, wherein the video receiving apparatus:
receives an establishing request message including information of a size and a format of videos to be received from a video transmitting apparatus;
determines whether a size or a format of the videos to be received is output;
when the videos to be received are output, generates the establishing response message, transmits the generated establishing response message to the video transmitting apparatus, and prepares for outputting the videos; and
receives video packets in which videos to be received are split into ZigBee packets from the video transmitting apparatus and stores the video packets in a receiving buffer; and
when data exceeding a predetermined capacity of the receiving buffer are stored in the receiving buffer, integrates the video packets stored in the receiving buffer as video data and sequentially outputs the integrated video data to a video output apparatus.

17. The video receiving apparatus of claim 16, wherein when a size or a format of the videos to be received is not output, an establishing response message is generated so as not to be transmitted to the video transmitting apparatus and the establishing request message is re-received.

18. The video receiving apparatus of claim 16, wherein a command message informing that transmission of the video packets corresponding to a single frame of the videos to be received ends is received from the video transmitting apparatus; and
an output position of the video data is initialized.

19. The video receiving apparatus of claim 16, wherein an ending message indicating that a transmission ending request is received from a user is received from the video transmitting apparatus;
an ending response message that is a response to the ending message is transmitted to the video transmitting apparatus; and
reception of the video packets stops and the video output apparatus is inactivated.

20. The video receiving apparatus of claim 16, wherein prior to receiving the establishing request message from the video transmitting apparatus, it configures a ZigBee network with the video transmitting apparatus.
